(19) United States
(12) Patent Application Publication
(10) Pub. No.: US 2015/0260684 A1
(43) Pub. Date: Sep. 17, 2015

(54) METHOD AND APPARATUS FOR ION MOBILITY SPECTROMETRY

(71) Applicants: DH Technologies Development Pte. Ltd., Singapore (SG); UNIVERSITY OF WOLLONGONG, Wollongong, NSW (AU)

(72) Inventors: Stephen J. Blanksby, Corrimal East (AU); John Lawrence Campbell, Milton (CA); Yves LeBlanc, Newmarket (CA); Alan T. Maccarone, North Wollongong (AU); Todd W. Mitchell, Wollongong (AU)

(21) Appl. No.: 14/431,422

(22) PCT Filed: Nov. 16, 2013
(86) PCT No.: PCT/IB2013/002574

§ 371 Date: Mar. 26, 2015

Related U.S. Application Data
(60) Provisional application No. 61/727,387, filed on Nov. 16, 2012.

(51) Int. Cl. G01N 27/62; H01J 49/10; H01J 49/00

(52) U.S. Cl. CPC G01N 27/624; H01J 49/0031; H01J 49/10

(57) ABSTRACT

Methods and systems for performing mass spectrometry are provided herein. The method includes ionizing one or more compounds to generate ions, passing the ions into an ion mobility spectrometer, providing ozone, reacting the ions with ozone to produce ozone-induced fragment ions, and performing mass analysis and detection of the ozone-induced fragment ions. The system can comprise an ion source for ionizing one or more compounds to generate ions, an ion mobility spectrometer for receiving and separating the ions, an ozone supply for introducing ozone into the system; a reaction region for reacting the ions with the ozone to produce ozone-induced fragment ions, and a mass spectrometer for performing mass analysis and detection of the ozone-induced fragment ions.

### RELATED APPLICATION

This application claims priority to U.S. provisional application No. 61/727,387 filed Nov. 16, 2012, which is incorporated herein by reference in its entirety.

### FIELD

The invention generally relates to mass spectrometry, and more particularly to methods and apparatus for ion/molecule chemistry and ion mobility spectrometry with mass spectrometry.

### INTRODUCTION

Mass spectrometry (MS) is an analytical technique for determining the elemental composition of test substances with both qualitative and quantitative applications. For example, MS can be useful for identifying unknown compounds, determining the isotopic composition of elements in a molecule, determining the structure of a particular compound by observing its fragmentation, and quantifying the amount of a particular compound in a sample.

MS analysis of complex samples (e.g., biological matrices) can sometimes result in inaccurate and/or non-specific detection as a result of interfering species contained within the sample that are not sufficiently resolved from the analyte of interest. Despite advances in MS that have enabled high-resolution mass analyzers to distinguish target species from interfering species within about 0.01 Th, it is not always feasible or possible to use a high-resolution mass analyzer or high-resolution analysis, for example, due to availability, cost, and/or experimental conditions.

The identification of the location of carbon-carbon double bonds in ions by mass spectrometry is a challenging problem, with many potential technologies claiming success but with severe limitations (i.e., poor SN, very long experiment cycle times, etc.) One technology that has shown promise is ozone-induced dissociation (or OzID), which provides very simple diagnostic fragment ions indicative of carbon-carbon double bond position in an ion. However, to date, the ozone used in these workflows has been located either within the vacuum region of the mass spectrometer or inside the ESI source. The former provides mass selectivity prior to OzID but obviously carries greater costs and barriers to entry for a customer; the latter provides much easier access to OzID but lacks any selection of precursor ions before reaction.

Accordingly, there remains a need for methods and systems for identifying the number and locations of carbon-carbon double bonds in compounds, such as, for example, lipids and other natural products.

### SUMMARY

In accordance with various embodiments of the applicants' teachings, there is provided a method for performing mass spectrometry. In various aspects, the method can comprise ionizing one or more compounds to generate ions, passing the ions into an ion mobility spectrometer, providing ozone, reacting the ions with ozone to produce ozone-induced fragment ions, and performing mass analysis and detection of the ozone-induced fragment ions. Ozone can enable improved specificity in discriminating between carbon-carbon double bond isomers. In various aspects, the one or more compounds can comprise lipids. In various embodiments, the ion mobility spectrometer can comprise for example, a differential mobility spectrometer (DMS), field asymmetric ion mobility spectrometry (FAIMS) devices of various geometries such as parallel plate, curved electrode, or cylindrical FAIMS device, among others. In various embodiments, the method can comprise reacting the ions with ozone prior to the ion mobility spectrometer, within the ion mobility spectrometer, or after the ion mobility spectrometer. In various aspects, ozone can be introduced in the curtain gas. In various aspects, the method can comprise reacting the ions with the ozone while transporting the ions through an ion mobility spectrometer. In various embodiments, the method can comprise reacting the ions with the ozone prior to transporting the ions through an ion mobility spectrometer. In various aspects, the method can comprise reacting the ions with the ozone subsequent to transporting the ions through an ion mobility spectrometer. In various aspects, ozone can be introduced in the throttle gas. In various aspects, ozone can be introduced into a reaction region for reaction with the ions between the ion mobility spectrometer and downstream mass spectrometer with or without the addition of a throttle gas.

In accordance with various embodiments of the applicants' teachings, there is provided a system for performing mass spectrometry. The system can comprise an ion source for ionizing one or more compounds to generate ions, an ion mobility spectrometer for receiving and separating the ions, an ozone supply for introducing ozone into the system; a reaction region for reacting the ions with the ozone to produce ozone-induced fragment ions, and a mass spectrometer for performing mass analysis and detection of the ozone-induced fragment ions. In various embodiments, the ion mobility spectrometer can comprise for example, a differential mobility spectrometer (DMS), FAIMS devices of various geometries such as parallel plate, curved electrode, or cylindrical FAIMS device, among others. In various embodiments, the system can further comprise a gas port for delivering ozone to the reaction region. In various embodiments, the ions can react with ozone prior to the ion mobility spectrometer, within the ion mobility spectrometer, or after the ion mobility spectrometer. In various aspects, ozone can be introduced in the curtain gas. In various aspects, the system can comprise′reacting the ions with the ozone in the reaction region while transporting the ions through an ion mobility spectrometer. In various embodiments, the system can comprise reacting the ions with the ozone in the reaction region prior to transporting the ions through an ion mobility spectrometer. In various aspects, the system can comprise reacting the ions with the ozone in the reaction region subsequent to transporting the ions through an ion mobility spectrometer. In various aspects, ozone can be introduced in the throttle gas. In various aspects, ozone can be introduced into a reaction region for reaction with the ions between the ion mobility spectrometer and downstream mass spectrometer with or without the addition of a throttle gas. In various aspects, the gas port can supply ozone into the reaction region. In various embodiments, the ozone can be configured to be bubbled through an ozone supply prior to introduction in the reaction region. In various embodiments, the gas port can be adjustable to vary a concentration of the ozone into the reaction region. In various aspects, the gas port can be adjustable to vary a gas flow rate through the ion mobility spectrometer.

These and other features of the applicants' teachings are set forth herein.

### BRIEF DESCRIPTION OF THE DRAWINGS

The skilled person in the art will understand that the drawings, described below, are for illustration purposes only. The drawings are not intended to limit the scope of the applicants' teachings in any way.

FIG. 1, in a schematic diagram, illustrates an exemplary differential mobility spectrometer/mass spectrometer in accordance with an aspect of various embodiments of the applicants' teachings.

FIG. 2, in a schematic diagram, illustrates an exemplary differential mobility spectrometer/mass spectrometer in accordance with an aspect of various embodiments of the applicants' teachings.

FIG. 3 shows three isomers having identical mass-to-charge values, in accordance with an aspect of various embodiments of the applicants' teachings.

FIG. 4 shows separation of carbon-carbon double bond isomers in accordance with aspects of various embodiments of the applicants' teachings.

FIG. 5 shows a table of predicted neutral losses or gains for ozone-induced product ions in accordance with aspects of various embodiments of the applicants' teachings.

### DETAILED DESCRIPTION

It will be appreciated that for clarity, the following discussion will explicate various aspects of embodiments of the applicants' teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicants' teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicants' teachings in any manner.

Methods and systems for performing mass spectrometry are provided herein. In accordance with various aspects of the applicants' teachings, the methods and systems can enable enhanced discrimination of carbon-carbon double bonds in compounds. In some broad aspects, the applicants' teachings relate to utilizing reactions between ozone and ionic species having substantially identical m/z ratios (e.g., ±2 Th) so as to cause sufficient change in their m/z ratios such that those species can be resolved from one another via mass spectrometry.

In accordance with various embodiments of the applicants' teachings, there is provided a method for performing mass spectrometry. The method can comprise ionizing one or more compounds to generate ions, passing the ions into an ion mobility spectrometer, providing ozone, reacting the ions with ozone to produce ozone-induced fragment ions, and performing mass analysis and detection of the ozone-induced fragment ions. Ozone can enable improved specificity in discriminating between carbon-carbon double bond isomers. In various aspects, the one or more compounds can comprise lipids. In various embodiments, the ion mobility spectrometer can comprise for example, a differential mobility spectrometer (DMS), FAIMS devices of various geometries such as parallel plate, curved electrode, or cylindrical FAIMS device, among others. In various embodiments, the ions can react with ozone prior to the ion mobility spectrometer, within the ion mobility spectrometer, or after the ion mobility spectrometer. In various aspects, ozone can be introduced in the curtain gas. In various aspects, the method can comprise reacting the ions with the ozone while transporting the ions through an ion mobility spectrometer. In various embodiments, the method can comprise reacting the ions with the ozone prior to transporting the ions through an ion mobility spectrometer. In various aspects, the method can comprise reacting the ions with the ozone subsequent to transporting the ions through an ion mobility spectrometer. In various aspects, ozone can be introduced in the throttle gas. In various aspects, ozone can be introduced into a reaction region for reaction with the ions between the ion mobility spectrometer and downstream mass spectrometer with or without the addition of a throttle gas.

In accordance with various embodiments of the applicants' teachings, there is provided a system for performing mass spectrometry. The system can comprise an ion source for ionizing one or more compounds to generate ions, an ion mobility spectrometer for receiving and separating the ions, an ozone supply for introducing ozone into the system; a reaction region for reacting the ions with the ozone to produce ozone-induced fragment ions, and a mass spectrometer for performing mass analysis and detection of the ozone-induced fragment ions. In various embodiments, the ion mobility spectrometer can comprise for example, a differential mobility spectrometer (DMS), FAIMS devices of various geometries such as parallel plate, curved electrode, or cylindrical FAIMS device, among others. In various embodiments, the system can further comprise a gas port for delivering ozone to the reaction region. In various embodiments, the ions can react with ozone prior to the ion mobility spectrometer, within the ion mobility spectrometer, or after the ion mobility spectrometer. In various aspects, ozone can be introduced in the curtain gas. In various aspects, the system can comprise reacting the ions with the ozone in the reaction region while transporting the ions through an ion mobility spectrometer. In various embodiments, the system can comprise reacting the ions with the ozone in the reaction region prior to transporting the ions through an ion mobility spectrometer. In various aspects, the system can comprise reacting the ions with the ozone in the reaction region subsequent to transporting the ions through an ion mobility spectrometer. In various aspects, ozone can be introduced in the throttle gas. In various aspects, ozone can be introduced into a reaction region for reaction with the ions between the ion mobility spectrometer and downstream mass spectrometer with or without the addition of a throttle gas. In various aspects, the gas port can supply ozone into the reaction region. In various embodiments, the ozone can be configured to be bubbled through an ozone supply prior to introduction in the reaction region. In various embodiments, the gas port can be adjustable to vary a concentration of the ozone into the reaction region. In various aspects, the gas port can be adjustable to vary a gas flow rate through the ion mobility spectrometer.

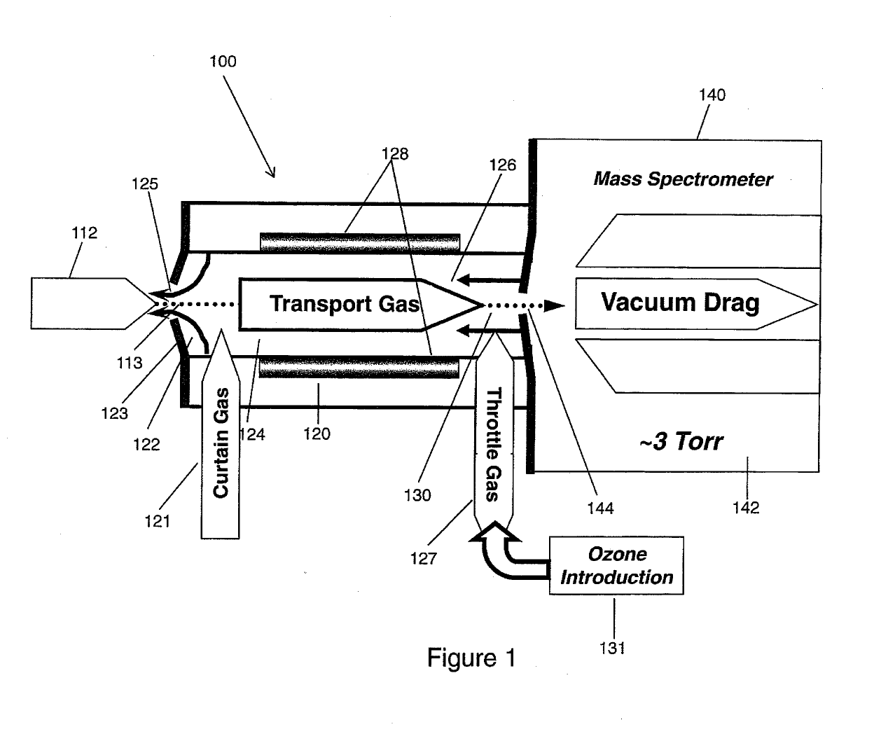

With reference now to FIG. 1, an exemplary mass spectrometry system 100 in accordance with various aspects of applicants' teachings is illustrated schematically. As will be appreciated by a person skilled in the art, the mass spectrometry system 100 represents only one possible configuration in accordance with various aspects of the systems, devices, and methods described herein. As shown in FIG. 1, the mass spectrometry system 100 generally includes an ion mobility spectrometer, exemplified by differential mobility spectrometer 120 in fluid communication with one or more lens elements 140 of a mass spectrometer (hereinafter generally designated mass spectrometer 140) and a reaction region 130, for example, disposed between the ion mobility spectrometer 120 and the mass spectrometer 140. In various embodiments, the reaction region can comprise a region for reacting the ions with the ozone to produce ozone-induced fragment ions. The ion mobility spectrometer 120 can utilize other techniques/systems for performing mobility spectrometry including, for example, a differential mobility spectrometer (DMS), FAIMS devices of various geometries such as parallel plate, curved electrode, or cylindrical FAIMS device, among others.

Ions 113 provided from an ion source 112 can be emitted into the curtain chamber 122 containing the differential mobility spectrometer 120 via curtain chamber orifice 125. As will be appreciated by a person skilled in the art, the ion source can be virtually any ion source known in the art, including for example, a continuous ion source, a pulsed ion source, an atmospheric pressure chemical ionization (APCI) source, an electrospray ionization (ESI) source, an inductively coupled plasma (ICP) ion source, a matrix-assisted laser desorption/ionization (MALDI) ion source, a glow discharge ion source, an electron ionization source, a chemical ionization source, or a photoionization ion source, among others.

The differential mobility spectrometer 120 can have a variety of configurations, but is generally configured to resolve ions received from the ion source 112 based on their mobility through a fixed or variable electric field. Though generally described herein as a differential mobility spectrometer, the mobility spectrometer 120 can utilize other techniques/systems for performing mobility spectrometry including, for example, an ion mobility spectrometer, FAIMS devices of various geometries such as parallel plate, curved electrode, or cylindrical FAIMS device, among others, and modified in light of the teachings herein.

In the exemplary embodiment depicted in FIG. 1, the ion mobility spectrometer shown, for example, as differential mobility spectrometer 120, can comprise opposed electrode plates 128 that surround a drift gas, also known as a transport gas, that drifts from an inlet 124 of the differential mobility spectrometer 120 to an outlet 126 of the differential mobility spectrometer 120. Whereas mass spectrometry (MS) analyzes ions based on their mass-to-charge ratios, ion mobility spectrometry instead separates ions based on their mobility through a gas in the presence of an electric field. The drift time through the flight tube and therefore the mobility of an ion is characteristic of the size and shape of the ion and its interactions with the background gas. Differential mobility spectrometry, also referred to as high field asymmetric waveform ion mobility spectrometry (FAIMS) or Field Ion Spectrometry (FIS), applies RF voltages, referred to herein as separation voltages (SV), across the electrode plates 128 to generate an electric force in a direction perpendicular to that of the drift gas flow. Ions of a given species tend to migrate radially away from the axis of the drift tube by a characteristic amount during each cycle of the RF waveform due to differences in mobility during the high field and low field portions. A DC potential, commonly referred to as a compensation voltage (CV or CoV), is applied to the electrode plates 128 to provide a counterbalancing electrostatic force to that of the SV. The CV can be tuned so as to preferentially prevent the drift of a species of ion of interest. Depending on the application, the CV can be set to a fixed value such that only ion species exhibiting a particular differential mobility are transmitted through the outlet 126 of the differential mobility spectrometer 120 (the remaining species of ions drift toward the electrodes 128 and are neutralized thereby). As will be appreciated by a person skilled in the art, the differential mobility spectrometer 120 can also operate in “transparent” mode, for example, by setting SV to zero such that substantially all ions are transmitted therethrough without experiencing a net radial force.

As shown in FIG. 1, the differential mobility spectrometer 120 can be contained within a curtain chamber 122 that is defined by a curtain plate or boundary member 123 having an orifice 125 for receiving ions from the ion source 112. As will be appreciated by a person skilled in the art, the curtain chamber 122 can be supplied with a curtain gas 121 from a curtain gas supply (not shown) at various flow rates, for example, as determined by a flow controller and valves. Moreover, the curtain gas supply can provide any pure or mixed composition curtain gas to the curtain gas chamber. By way of non-limiting example, the curtain gas can be air, O₂, He, N₂, CO₂, O₃, or any combination thereof. The pressure of the curtain gases in the curtain chamber 122 can be maintained at or near atmospheric pressure (i.e., 760 Torr). The system 100 can also include a modifier supply (not shown) for supplying a modifier agent to the curtain gas to cluster with ions differentially during the high and low field portions of the SV. By way of example, the modifier supply can be a reservoir of a solid, liquid, or gas through which the curtain gas can be delivered to the curtain chamber 122. The modifier supply can provide any modifier to the curtain gas including, by way of non-limiting example, water, methanol, acetone, isopropanol, methylene chloride, methylene bromide, or any combination thereof. In some embodiments, the curtain chamber 122 and/or the differential mobility spectrometer 120 can additionally include a heater for heating the curtain gas, the modifier, and/or the drift gas to control, for example, the proportion of modifier in the curtain and/or drift gas.

The pressure of the curtain gases in the curtain chamber 122 (e.g., ˜760 Torr) can provide both a curtain gas outflow out of curtain gas orifice 125, as well as a curtain gas inflow into the differential mobility spectrometer 120, which becomes the drift or transport gas that carries the ions through the differential mobility spectrometer 120 and into a reaction region 130 that, for example, defines a path of travel for the ions between the differential mobility spectrometer 120 and the mass spectrometer 140 contained within the vacuum chamber 142. In some embodiments, for example, the outlet 126 of the differential mobility spectrometer 120 can be aligned with the inlet 144 of the mass spectrometer 140 to define the ion path of travel therebetween, while the walls of the reaction region 130 are spaced from this path of travel to provide an increased reaction volume.

In various embodiments, the reaction region 130 can additionally comprise a port through which, for example, a throttle gas and/or ozone can be introduced into the reaction region 130. Ozone can enable improved specificity in discriminating between carbon-carbon double bond isomers via a chemical reaction between the ozone molecule and a carbon-carbon double bond. This reaction results in the oxidative cleavage of carbon-carbon double bonds present in a molecule or ion. While the intact masses (or mass-to-charge ratios) for carbon-carbon double bond isomers will be identical, each isomer will cleave at different locations, depending upon the position of the carbon-carbon double bond. Hence, each isomer will produce different ozonolysis products, enabling their differentiation and unambiguous identification of this structural feature. In various aspects, a throttle gas comprising N₂ can be bubbled through an ozone supply 131 containing ozone such that the throttle gas carries the ozone into the reaction region 130 for use in an ion/molecule reaction with the ions that are transmitted by the differential mobility spectrometer 120. As will be appreciated by a person skilled in the art, the flow of the throttle gas through the ozone supply 131 and into the reaction region 130 can be controlled by a controllable valve, for example, and selected so as to throttle back (i.e., slow) the flow of the drift gas through the differential mobility spectrometer 120 and/or control the concentration of ozone in the reaction region 130. In various embodiments, the amount of produced ozone can also be modified by altering the power supplied to the ozone-generating device, such as a corona discharge, ultraviolet lamp, or other device. In various aspects, control of the amount of ozone can also be affected by adjusting the ratio of oxygen present in the gas source that enters the ozone generator. By way of example, the flow of throttle gas into the reaction region 130 can be modified so as to modulate the gas flow rate through the differential mobility spectrometer 120, thereby controlling the residence time of ions within the differential mobility spectrometer 120. In various embodiments, for example, the inflow of throttle gas can be modulated by controlling a gas port. Moreover, the gas port can be oriented to direct the throttle gas and/or ozone throughout the reaction region 130, and in some embodiments, without disrupting the gas streamlines between the differential mobility spectrometer 120 and the vacuum chamber inlet 144. In various embodiments, the location of the ozone generation can occur anywhere along the curtain gas line and the throttle gas line, and need not be the same for each gas line. For example, ozone generation can occur in-line with these gas lines, positioned close to the outlet of these gas lines. Alternatively, in various aspects, the ozone generator can be positioned at the input of these gas lines.

As will be appreciated by a person skilled in the art, the vacuum chamber 142 can be maintained at a much lower pressure than the curtain chamber 122. For example, the vacuum chamber 142 can be maintained at a pressure of about 2.3 Torr by a vacuum pump (not shown), while the curtain chamber 122 and an internal operating pressure of the differential mobility spectrometer 120 can be maintained at a pressure of 760 Torr. As a result of the significant pressure differential between the curtain chamber 122 and the vacuum chamber 142, the drift gas can be drawn through the differential mobility spectrometer 120, the reaction region 130 and, via vacuum chamber inlet 144, into the vacuum chamber 142 and mass spectrometer 140. As shown, the mass spectrometer 140 can be sealed to (or at least partially sealed), and in fluid communication with the differential mobility spectrometer 120, via the reaction region 130, to receive the ions transmitted by the differential mobility spectrometer 120.

Though only mass spectrometer 140 is shown, a person skilled in the art will appreciate that the mass spectrometry system 100 can include additional mass analyzer elements downstream from the vacuum chamber 142. As such, ions transported through vacuum chamber 142 can be transported through one or more additional differentially pumped vacuum stages containing one or more mass analyzer elements. For instance, in various aspects, a triple quadrupole mass spectrometer may comprise three differentially pumped vacuum stages, including a first stage maintained at a pressure of approximately 2.3 Torr, a second stage maintained at a pressure of approximately 6 mTorr, and a third stage maintained at a pressure of approximately 10⁻⁵ Torr. The third vacuum stage can contain, for example, a detector, as well as two quadrupole mass analyzers (e.g., Q1 and Q3) with a collision cell (Q3) located between them. It will be apparent to those skilled in the art that there may be a number of other ion optical elements in the system. This example is not meant to be limiting as it will also be apparent to those of skill in the art that the ion mobility spectrometer/mass spectrometer coupling can be applicable to many mass spectrometer systems that sample ions from elevated pressure sources. These can include time of flight (TOF), ion trap, quadrupole, or other mass analyzers, as known in the art.

In various embodiments, as will be appreciated by a person skilled in the art, the vacuum chamber inlet 144 can be an orifice, or, alternatively, may be a capillary, heated capillary, or an ion pipe. In various embodiments of the present teachings, it can be advantageous to provide a braking potential (e.g., by providing a DC offset voltage to either the electrode plates 128 of the differential mobility spectrometer 120 relative to the declustering or inlet potential provided to the vacuum chamber inlet 144) to slow down the ions transmitted into the reaction region 130 from the differential mobility spectrometer 120. By slowing down the ions prior to entering the vacuum chamber 142, the exposure of the ions to the ozone can be increased, thereby increasing the chemical reaction, and ultimately, increasing the sensitivity of detection by the mass spectrometer 140.

In various embodiments, separate sources can be provided for the throttle gas and ozone. In various embodiments, a person skilled in the art will appreciate that systems in accord with the teachings herein can comprise a single gas source that divides into two branches that can be independently controlled to effect differences in the gas flow to the reaction region 130 and curtain chamber 122. It will further be appreciated that ozone can be introduced into the reaction region 130 downstream of the differential mobility spectrometer 120, as shown in FIG. 1. In various aspects, ion/molecule reactions can be initiated in various locations throughout the mass spectrometry system 100. In various embodiments, the ions can react with ozone to produce ozone-induced fragment ions. By way of example, a gas port can instead be disposed upstream of the differential mobility spectrometer 120 such that ozone can react with the ions prior to or during their transmission through the differential mobility spectrometer 120. Moreover, it will be appreciated that ozone can be introduced into a reaction region 130 for reaction with the ions between a differential mobility spectrometer 120 and downstream mass spectrometer elements with or without the addition of a throttle gas.

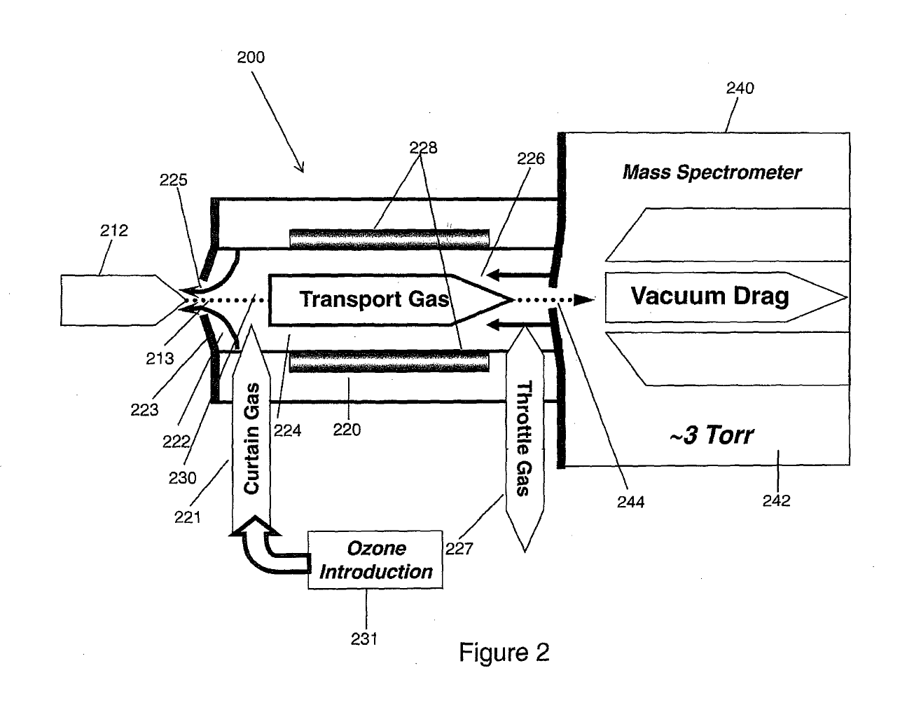

With reference now to FIG. 2, there is illustrated in a schematic diagram, a mass spectrometer system 200 in accordance with various embodiments of the present invention. For clarity, elements of the system 200 of FIG. 2 that are analogous to elements of the system 200 of FIG. 1 are designated using the same reference numerals as in FIG. 1, with 100 added. The mass spectrometry system 200 is substantially similar to that depicted in FIG. 1 but differs in that ozone can be introduced into the region prior to the ion mobility spectrometer, exemplified by differential mobility spectrometer 220, as shown in FIG. 2. In various embodiments, ozone can react with the ions prior to or during their transmission through the differential mobility spectrometer 220. In various embodiments, ozone can be introduced into a reaction region 230 for reaction with the ions prior to or within the differential mobility spectrometer. In various aspects, the ions can react with ozone to produce ozone-induced fragment ions. In various embodiments, the reaction region 230 can additionally comprise a port through which a curtain gas and/or ozone can be introduced into the reaction region 230. In various aspects, a curtain gas comprising N₂ can be bubbled through an ozone supply 231 containing ozone such that the curtain gas carries the ozone into the reaction region 230 for use in an ion/molecule reaction with the ions that are transmitted by the differential mobility spectrometer 220. As will be appreciated by a person skilled in the art, the flow of the curtain gas containing ozone into the reaction region 230 can be controlled by a controllable valve to control the concentration of ozone in the reaction region 230. By way of example, the flow of curtain gas into the reaction region 230 can be modified so as to modify the gas flow rate through the differential mobility spectrometer 220, thereby controlling the residence time of ions within the differential mobility spectrometer 220. In various embodiments, for example, the inflow of curtain gas can be controlled by controlling a gas port. Moreover, the gas port can be oriented to direct the curtain gas and/or ozone throughout the reaction region 230, and in some embodiments, without disrupting the gas streamlines between the differential mobility spectrometer 220 and the vacuum chamber inlet 244. In various aspects, a heater can be provided.

In various embodiments, separate sources can be provided for the curtain gas and ozone. In various embodiments, a person skilled in the art will appreciate that systems in accord with the teachings herein can comprise a single gas source that divides into two branches that can be independently controlled to effect differences in the gas flow to the reaction region 230 and curtain chamber 222.

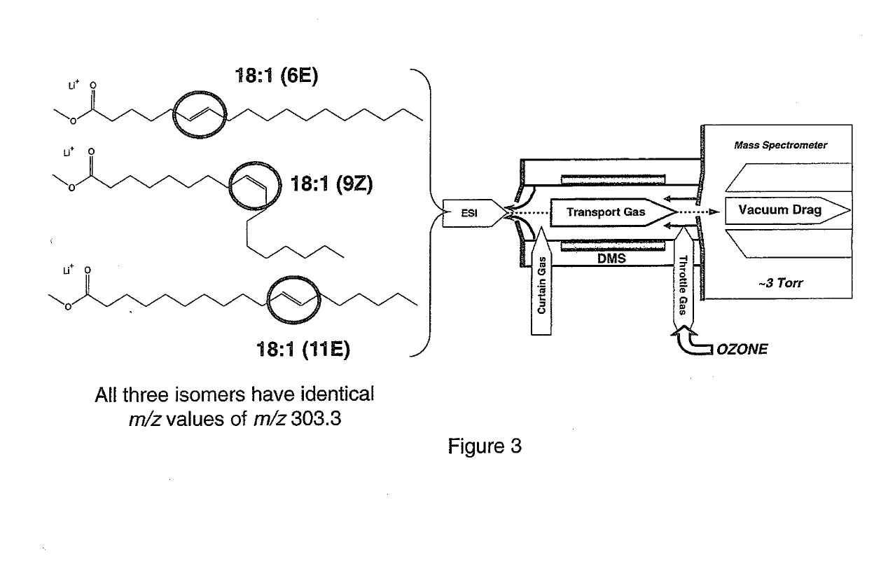

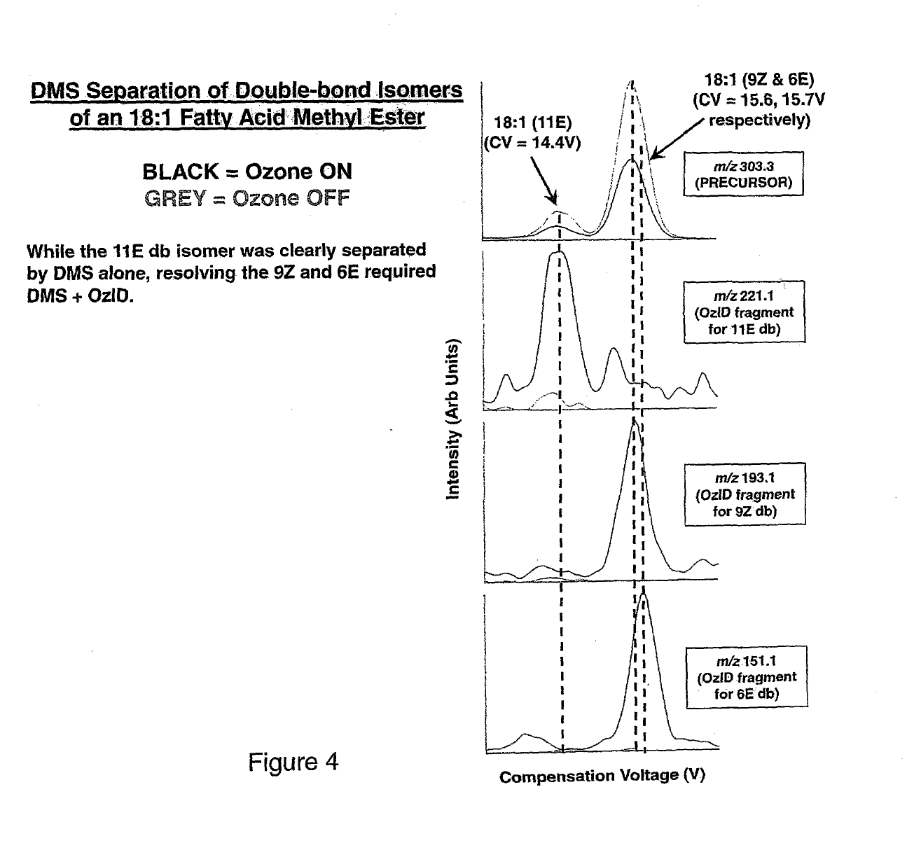

The applicants' teachings can be even more fully understood with reference to the exemplary experiment presented in FIGS. 3 and 4. FIG. 3 shows a mixture of three isomeric monounsaturated lipid ions, 6E, 9Z, and 11E, all 18:1, lithiated, to produce ions of m/z values of 303.3. While the 11E carbon-carbon double bond isomer was clearly separated from the mixture by the DMS (peak at CV=14.4V), the precursor ions for the other two isomers (6E and 9Z) transmit at essentially the same CV (˜15.6V). This degree of separation is afforded, in part, by increasing the residence time of the ions inside the DMS cell using throttle gas flow. However, while these isomeric ions were, to a degree, separated by the DMS using air as the throttle gas, identification of the individual isomers is only afforded by the addition of ozone to the throttle gas. Otherwise, the analysis of lipid standards is required, which can be a prolonged and expensive process. Instead, the addition of ozone to the throttle gas allows an OzID reaction to occur post-DMS separation, whereby the characteristic OzID product ions for each carbon-carbon double bond isomer can be detected by the mass spectrometer. FIG. 4 shows the ozone-induced fragment ions for all three lipid isomers that are observed and the separation of the three carbon-carbon double bond isomers of FIG. 3, including separation between the 6E and 9Z isomers at 15.7V and 15.6V respectively when ozone is introduced into the throttle gas and reacts with ions exiting the differential mobility spectrometer.

Experimental conditions were as follows: A differential mobility spectrometer (SelexION™, AB SCIEX, Concord, ON) system was mounted on a 5500 QTRAP® system (AB SCIEX), between a TurboV™ ESI source and the mass spectrometer's sampling orifice (FIG. 1). The ESI probe was maintained at a voltage of 5000 V, with a source temperature of 150° C., nebulizing gas pressure of 20 psi, and auxiliary gas pressure of 20 psi. The DMS temperature was maintained at 150° C., and nitrogen was used as the curtain gas (3.5 L/min), and air was used as the throttle gas (2.0 L/min). An ozone generator was placed in-line with the throttle gas and was activated for ˜5 minutes prior to use in the ozonolysis experiments. Analyte solutions (˜100 ng/mL) were infused into the ESI source at a rate of 20 μL/min. The differential mobility spectrometer was operated with a separation voltage (SV) held at an optimum value (+4000 V) while the compensation voltage (CV) was scanned from +10V to +20V in 0.1-V increments. At each CV increment, a mass spectrum was acquired that targeted the detection of precursor lipid ion isomer, as well as the characteristic ozonolysis products of each lipid ion isomer.

In various embodiments, by introducing ozone gas into the throttle gas zone of a differential mobility spectrometer (DMS), we can exploit the separation powers of the DMS while probing the ion structures with ion/molecule reactions post-DMS. Subsequently, we can use tandem MS to probe the ion structure of either the precursor ion, the OzID-product ions, or both.

In various aspects, a potential workflow for the DMS-OzID-MS/MS experiments can involve first DMS optimization for a class of lipid ions. With the DMS operating in “ozone OFF” mode, a survey can be conducted to identify any double-bond containing lipid ions (generally from characteristic MS/MS fragment ions or neutral losses).

Next, with these double-bond containing lipids identified, a DMS-OzID experiment can be initiated. With the system in the “ozone ON” mode, the MS can be set to pass only those ions that are indicative of an OzID double-bond cleavage.

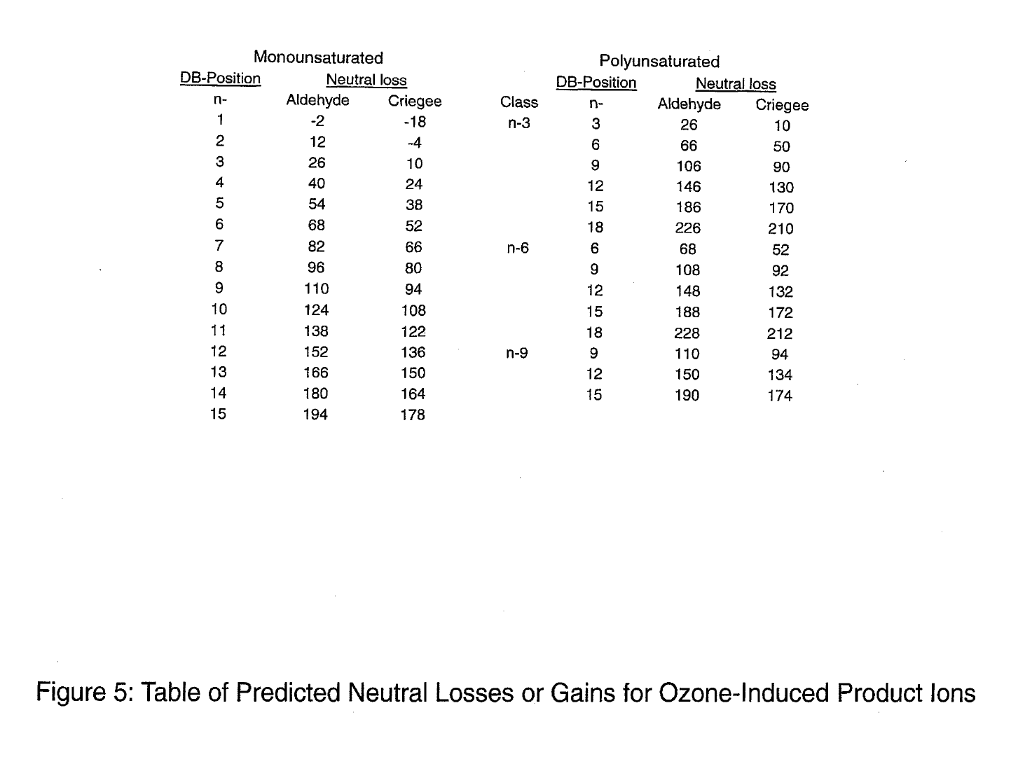

For example, if a parent ion of m/z 300 is identified as containing a carbon-carbon double bond, we can survey the “ozone ON” mass spectra for ions with m/z values fitting the neutral losses of specific double-bond positions. Referring to Table 1 in FIG. 5 which shows predicted neutral losses or gains for ozone-induced product or fragment ions showing the dependence on position and degree of unsaturation, an n-6 carbon-carbon double bond cleavage from the m/z 300 ion would produce a DMS-OzID product ion of m/z (300−68)=m/z 232.

This ion would share common DMS properties of the precursor lipid ion (same SV and CV), marking it as a unique OzID fragment of the specific lipid.

As such, methods and systems in accord with various aspects of the teachings herein enable improved specificity in discriminating between carbon-carbon double bond isomers.

The section headings used herein are for organizational purposes only and are not to be construed as limiting. While the applicants' teachings are described in conjunction with various embodiments, it is not intended that the applicants' teachings be limited to such embodiments. On the contrary, the applicants' teachings encompass various alternatives, modifications, and equivalents, as will be appreciated by those of skill in the art.

1. A method for performing mass spectrometry, comprising:
a. ionizing one or more compounds to generate ions;
b. passing the ions into an ion mobility spectrometer;
c. providing ozone;
d. reacting the ions with ozone to produce ozone-induced fragment ions; and
e. performing mass analysis and detection of the ozone-induced fragment ions.

2. The method of claim 1, wherein the one or more compounds comprise lipids.

3. The method of claim 1, wherein the ion mobility spectrometer comprises a differential mobility spectrometer.

4. The method of claim 1, comprising reacting the ions with the ozone while transporting the ions through an ion mobility spectrometer.

5. The method of claim 1, comprising reacting the ions with the ozone prior to transporting the ions through an ion mobility spectrometer.

6. The method of claim 1, comprising reacting the ions with the ozone subsequent to transporting the ions through an ion mobility spectrometer.

7. A system for performing mass spectrometry, comprising:
a. an ion source for ionizing one or more compounds to generate ions;
b. an ion mobility spectrometer for receiving and separating the ions;
c. an ozone supply for introducing ozone into the system;
d. a reaction region for reacting the ions with the ozone to produce ozone-induced fragment ions; and
e. a mass spectrometer for performing mass analysis and detection of the ozone-induced fragment ions.

8. The system of claim 7, wherein the ion mobility spectrometer comprises a differential mobility spectrometer.

9. The system of claim 7, comprising reacting the ions with the ozone in the reaction region while transporting the ions through an ion mobility spectrometer.

10. The system of claim 7, comprising reacting the ions with the ozone in the reaction region prior to transporting the ions through an ion mobility spectrometer.

11. The system of claim 7, comprising reacting the ions with the ozone in the reaction region subsequent to transporting the ions through an ion mobility spectrometer.

12. The system of claim 7, further comprising a gas port for delivering ozone to the reaction region.

13. The system of claim 12, wherein the ozone is configured to be bubbled through an ozone supply prior to introduction in the reaction region.

14. The system of claim 12, wherein the gas port is adjustable to vary a concentration of the ozone into the reaction region.

15. The system of claim 12, wherein the gas port is adjustable to vary a gas flow rate through the ion mobility spectrometer.
